(19) United States
(12) Patent Application Publication
(10) Pub. No.: US 2023/0118133 A1
(43) Pub. Date: Apr. 20, 2023

(54) VACUUM INTERRUPTER AND VACUUM BREAKER

(71) Applicant: MEIDENSHA CORPORATION, Tokyo (JP)

(72) Inventor: Hideaki FUKUDA, Numazu-shi, Shizuoka (JP)

(73) Assignee: MEIDENSHA CORPORATION, Tokyo (JP)

(21) Appl. No.: 17/913,491

(22) PCT Filed: Mar. 18, 2021
(86) PCT No.: PCT/JP2021/011123

§ 371 Date: Sep. 26, 2022

(30) Foreign Application Priority Data
Mar. 23, 2020 (JP) 2020-051903

(51) Int. Cl. H01H 33/662; H01H 33/664; H01H 33/666; H01H 33/66

(52) U.S. Cl. CPC H01H 33/66238; H01H 33/664; H01H 33/666; H01H 33/6606

(57) ABSTRACT

An arc shield surrounding an outer peripheral side of a fixed electrode and a movable electrode is provided, in addition to a fixed-side insulating unit in which a fixed-side insulator is provided to be connected coaxially with the arc shield on the fixed side in the axial direction of the arc shield, and a movable-side insulating unit in which movable-side insulators are provided to be connected coaxially with the arc shield on the movable side in the axial direction of the arc shield. The movable-side insulating unit has an insulator group in which movable-side insulators are provided to be connected in the axial direction, an insulator-group-side sub shield surrounding the outer peripheral side of a movable-side energizing shaft, and an insulator-group-side sub shield support part which is on the outer peripheral surface of the insulator-group-side sub shield and interposed between two adjacent movable-side insulators of the insulator group.

### TECHNICAL FIELD

The present invention relates to a vacuum breaker applied to, for example, various power facilities, and to a vacuum interrupter which can be applied to the vacuum breaker.

### BACKGROUND TECHNOLOGY

As a vacuum breaker applied to, for example, a power facility, one incorporating a vacuum interrupter as a current breaking unit has been known. In these vacuum breaker and vacuum interrupter, recently, the expansion of application to high-voltage power system has been expected, and various improvement has been considered in order to obtain a desired characteristic (for example, insulation performance).

A numeral “9” in FIG. 4 indicates a commonly known vacuum interrupter, and a vacuum vessel 91 is used in which a fixed side that is one end side in the axial direction of an insulating cylindrical body 90 (hereinafter is simply referred to as “axial direction”) is sealed with a fixed-side flange 91a and a movable side that is the other end side in the axial direction is sealed with a movable-side flange 91b. The cylindrical body 90 is one including an arc shield 9c, a fixed-side insulating unit 9a and a movable-side insulating unit 9b each having a cylindrical shape, and has a structure in which the arc shield 9c is sandwiched between the fixed-side insulating unit 9a and the movable-side insulating unit 9b so as to be coaxially arranged.

A fixed-side energizing shaft 92a is provided on the vacuum vessel 91 inner side of the fixed-side flange 91a so as to extend from the vacuum vessel 91 inner side in the axial direction, and a fixed electrode 93a is supported on an end portion of the fixed-side energizing shaft 92a. The movable-side flange 91b is provided with a movable-side energizing shaft 92b extending in the axial direction so as to pass through the movable-side flange 91b in the axial direction.

The movable-side energizing shaft 92b is supported on the vacuum vessel 91 inner side of the movable-side flange 91b via a bellows 92c which is freely extensible in the axial direction, so as to be freely movable in the axial direction. A movable electrode 93b is supported on an end portion of the movable-side energizing shaft 92b so as to come in contact with and separate from the fixed electrode 93a according to the movement of the movable-side energizing shaft 92b.

In a patent document 1, a configuration is disclosed in which, in addition to an arc shield which surrounds the outer peripheral side of contacts, shields which are referred to as sub shields (in the following, the arc shield and the sub shields are simply referred to as shields as needed) are disposed in order to reduce an electric field value of the end portion of each of the shields. Specifically, a configuration is disclosed in which a vacuum vessel having a multistage insulating structure in which a plurality of cylindrical insulators are provided so as to be connected to each other in the axial direction is applied, and the shields are supported between two adjacent cylindrical insulators (for example, FIG. 1 and FIG. 8 in the patent document 1).

A vacuum interrupter as a single body shown in, for example, the patent document 1 has insulation performance to a certain extent, such that even in case of being incorporated in a vacuum breaker whose outer peripheral side is covered with an insulating tube, a desired insulation performance can be obtained. As an application example of such a vacuum interrupter, for example, as shown in a patent document 2, a configuration has been known in which two vacuum interrupters are incorporated in series per phase of a vacuum breaker so as to improve insulation performance by dividing voltage applied at the time of contact opening.

### PRIOR ART REFERENCE(S)

### Patent Document(s)

Patent Document 1: Japanese Patent No. 5243575

Patent Document 2: Japanese Patent No. 6044645

Patent Document 3: Japanese Patent Application Publication No. H10-224923

### SUMMARY OF THE INVENTION

Each of the shields provided to the above-mentioned vacuum interrupter acts as a floating electrode, in case where there is a grounding object on the outer peripheral sides of the shields. Then, electrostatic capacity is constituted between the shields and the grounding object (hereinafter is appropriately referred to as “between adjacent electrodes”).

That is, in case where the above-mentioned vacuum interrupter is simply incorporated in the vacuum breaker, fluctuations in potential due to the electrostatic capacity between the adjacent electrodes mentioned above easily occur, and there is a possibility that the balance of potential sharing inside the vacuum breaker is hardly kept. Consequently, it can be considered that an electric field locally rises or a desired insulation performance cannot be obtained.

In order to keep the balance of the potential sharing, for example, it can be considered to adjust electrostatic capacity by appropriately setting the distance between adjacent electrodes (by appropriately setting, for example, the shapes, arrangement configuration and the like of shields). However, there is a possibility that insulation distance becomes short caused by the adjustment, and insulation performance deteriorates.

Moreover, as shown in the patent document 1, in case where a vacuum vessel having a multistage insulating structure in which a plurality of cylindrical insulators are continuously provided simply, the dimension in the axial direction per cylindrical insulator becomes short. That is, a sufficient insulation distance cannot be secured, and there is a possibility that creeping discharge easily occurs on the outer peripheral side of the vacuum vessel.

In addition, although it can be considered to forcibly fix potential by arranging a voltage sharing capacitor in parallel with a vacuum interrupter as shown in the patent document 2, there is a possibility that the size of a vacuum breaker becomes large or costs become high.

The present invention has been made in consideration of such a technical problem, and an object of the present invention is to provide a technique capable of easily obtaining a desired insulation performance in a vacuum breaker by easily suppressing the creep discharge of a vacuum interrupter.

The vacuum interrupter and the vacuum breaker according to the present invention is one which is capable of contributing to solve the problem, and the vacuum interrupter, in one aspect thereof, includes: a vacuum vessel including an insulating cylindrical body, and having a fixed side which is one end side in an axial direction of the cylindrical body and is sealed with a fixed-side flange and a movable side which is the other end side in the axial direction and is sealed with a movable-side flange; a fixed-side energizing shaft extending from a vacuum vessel inner side of the fixed-side flange in the axial direction; a fixed electrode supported the an end portion on an extending direction side of the fixed-side energizing shaft; a movable-side energizing shaft which extends in the axial direction while passing through the movable-side flange in the axial direction, and is supported on the vacuum vessel inner side of the movable-side flange via a bellows which is extensible in the axial direction, so as to be movable in the axial direction; and a movable electrode which is supported on the end portion on the vacuum vessel inner side of the movable-side energizing shaft so as to face the fixed electrode, and comes in contact with and separates from the fixed electrode in accordance with the movement of the movable-side energizing shaft.

Then, the cylindrical body includes: a cylindrical arc shield which surrounds the outer peripheral side of the fixed electrode and the movable electrode; a fixed side insulating unit in which a cylindrical fixed-side insulator is provided so as to be connected coaxially with the arc shield on the fixed side in the axial direction of the arc shield; and a movable-side insulating unit in which cylindrical movable-side insulators are provided so as to be connected coaxially with the arc shield on the movable side in the axial direction of the arc shield, and the movable-side insulating unit includes: an insulator group in which a plurality of the movable-side insulators, a number of which is larger than that of the fixed-side insulator, are provided so as to be connected in the axial direction; a cylindrical insulator-group-side sub shield surrounding the outer peripheral side of the movable-side energizing shaft; and an insulator-group-side sub shield support part which is provided on the outer peripheral surface of the insulator-group-side sub shield, and is supported by being interposed between two adjacent movable-side insulators of the insulator group.

In one aspect of the vacuum interrupter, the inner diameter on the fixed side in the axial direction of the insulator-group-side sub shield may be smaller than that on the movable side in the axial direction of the insulator-group-side sub shield.

In addition, the vacuum interrupter may further include a cylindrical movable-side sub shield which extends from the vacuum vessel inner side of the movable-side flange in the axial direction and surrounds the outer peripheral side of the movable-side energizing shaft, on the inner peripheral side of the insulator-group-side sub shield, and the outer diameter of the movable-side sub shield may be smaller than the inner dimeter of the insulator-group-side sub shield, and the inner diameter of the movable-side sub shield may be larger than the outer diameter of the movable-side energizing shaft and the outer diameter of the movable electrode.

In addition, the distal end portion on the extending direction side of the movable-side sub shield may be formed with a movable-side reduced diameter portion having a shape bent toward the axis side of the movable-side sub shield.

In addition, the vacuum interrupter may further include a cylindrical fixed-side sub shield which extends from the vacuum vessel inner side of the fixed-side flange in the axial direction and surrounds the outer peripheral side of the fixed-side energizing shaft on the inner peripheral side of the arc shield, and the outer diameter of the fixed-side sub shield may be smaller than the inner dimeter of the arc shield, and the distal end portion on the extending direction side of the fixed-side sub shield may be positioned more on the fixed side in the axial direction than the contacts of the fixed electrode and the movable electrode.

In addition, the distal end portion on the extending direction side of the fixed-side sub shield may be formed with a fixed-side reduced diameter portion having a shape bent toward the axis side of the fixed-side sub shield.

In addition, the arc shield may be biased toward the fixed side in the axial direction from the contacts of the fixed electrode and the movable electrode.

In addition, the insulator-group-side sub shield may have characteristics that the outer diameter on the fixed side in the axial direction of the insulator-group-side sub shield is smaller than an inner diameter on the movable side in the axial direction of the arc shield, and the fixed side in the axial direction of the insulator-group-side sub shield is inserted into the inner peripheral side of the arc shield so as to be superimposed with the arc shield in the axial direction in a non-contact state with each other.

One aspect of the vacuum breaker is a vacuum breaker which is provided with a pair of the vacuum interrupters, and includes: a grounding tank which accommodates the pair of the vacuum interrupters arranged on the same line in a posture in which the movable-side flanges of the pair of the respective vacuum interrupters face each other; a link mechanism which is provided inside the grounding tank and electrically connects the movable-side energizing shafts of the pair of the respective vacuum interrupters so as to be freely movable in the axial direction; and an operation part which is provided on the outer peripheral side of the grounding tank and operates the link mechanism via an insulation operation rod connected to the link mechanism.

In one aspect of the vacuum breaker, cylindrical outer-peripheral-side sub shields surrounding outer peripheral sides of the respective fixed-side insulating units of the pair of the vacuum interrupters are provided on the outer peripheral sides of the respective fixed-side insulating units of the pair of the vacuum interrupters, and each of the outer-peripheral-side sub shields is superimposed with corresponding one of the arc shields of the respective vacuum interrupters in the axial direction.

According to the present invention mentioned above, it is possible to suppress the creep discharge of a vacuum interrupter so as to easily obtain a desired insulation performance in a vacuum breaker.

### BRIEF DESCRIPTION OF THE DRAWINGS

FIG. 1 is a schematic diagram for explaining a schematic configuration of a vacuum interrupter 1A (1B) in an embodiment (sectional view in the axial direction of a vacuum vessel 1 (in the right and left direction in the drawing)).

FIG. 2 is a schematic diagram for explaining a schematic configuration of a vacuum breaker 7 in an embodiment (sectional view in the axial direction of a grounding tank 71 (in the right and left direction in the drawing)).

FIG. 3 is an equivalent circuit diagram for explaining electrostatic capacity characteristics of the vacuum breaker 7.

FIG. 4 is a schematic diagram for explaining one example of a common vacuum interrupter.

FIG. 5 is an equivalent circuit diagram for explaining electrostatic capacity characteristics in case where the vacuum interrupter 9 is applied.

### MODE FOR IMPLEMENTING THE INVENTION

A vacuum interrupter and a vacuum breaker provided with the vacuum interrupter according to an embodiment of the present invention is totally different from the configuration (hereinafter is referred to as a conventional configuration) in which a plurality of shields are simply provided or a vacuum vessel having a multistage insulating structure is applied.

That is, in the vacuum interrupter and the vacuum breaker according to the present embodiment, the configuration on the fixed side (fixed electrode side) and the configuration on the movable side (movable electrode side) in the axial direction of the vacuum interrupter (hereinafter is simply referred to as an axial direction) are asymmetric, and as compared with the movable side of the vacuum interrupter, the fixed side is configured such that insulation distance can be easily secured, and as compared with the fixed side of the vacuum interrupter, the movable side is configured such that electrostatic capacity can be easily adjusted.

More specifically, a vacuum vessel which is capable of accommodating a fixed electrode (fixed side) and a movable electrode (movable side) so as to come in contact with and separate from each other in the axial direction includes a cylindrical arc shield surrounding the outer peripheral side of the fixed electrode and the movable electrode, a fixed side insulating unit in which a cylindrical fixed-side insulator is provided so as to be connected coaxially with the arc shield on the fixed side in the axial direction of the arc shield, and a movable-side insulating unit in which cylindrical movable-side insulators are provided so as to be connected coaxially with the arc shield on the movable side in the axial direction of the arc shield.

Then, in the movable-side insulating unit, there are provided with an insulator group in which a plurality of the movable-side insulators, the number of which is larger than that of the fixed-side insulator, are provided so as to be connected in the axial direction, a cylindrical insulator-group-side sub shield surrounding the outer peripheral side of a movable-side energizing shaft, and an insulator-group-side sub shield support part which is provided on the outer peripheral surface of the insulator-group-side sub shield, and is supported by being interposed between two adjacent movable-side insulators of the insulator group.

According to such an asymmetrical configuration, as compared with the movable electrode side of the vacuum interrupter, on the fixed electrode side, insulation distance can be easily secured, and. it is possible to suppress creep discharge easily. On the other hand, as compared with the fixed electrode side of the vacuum interrupter, on the movable electrode side, the distance between adjacent electrodes is appropriately set, thereby adjusting electrostatic capacity easily.

In case of configuring a vacuum breaker by applying a pair of vacuum interrupters mentioned above, the pair of the vacuum interrupters arranged on the same line is accommodated in a grounding tank in a posture in which the movable electrode sides of the pair of the respective vacuum interrupters face each other.

Accordingly, although, for example, a high voltage which can be generated at the time of contact opening is applied from the fixed electrode side of the vacuum interrupter, on the fixed electrode side, insulation distance can be secured easily as mentioned above, and creep discharge can be sufficiently suppressed and an insulation breakdown phenomenon can also be suppressed.

On the movable electrode side of the vacuum interrupter, similar to the fixed electrode side, the applying of a high voltage can be suppressed, and even in case where, for example, the distance between adjacent electrodes is appropriately set (for example, the shape or arrangement configuration of the shields is appropriately set) to keep the balance of potential sharing so as to adjust electrostatic capacity, a sufficient insulation. performance can also be secured on the movable electrode side.

Therefore, according to the vacuum breaker provided with the vacuum interrupter of the present embodiment, as compared with case where a conventional configuration is applied, a desired insulation performance can be obtained easily In addition, even if, for example, a voltage sharing capacitor as shown in a patent document 3 is not applied, in the vacuum breaker, a desired insulation performance can be exhibited, and it is also possible to reduce the size and costs.

In the present embodiment, a vacuum interrupter has a asymmetrical configuration as mentioned above and a vacuum breaker is sufficient to have a configuration in which a pair of the vacuum interrupters is appropriately accommodated, and design change is possible by appropriately applying common general knowledge of various fields (such as a vacuum breaker field) while appropriately referring to prior art references as needed.

<<Embodiment of Vacuum Interrupter>>

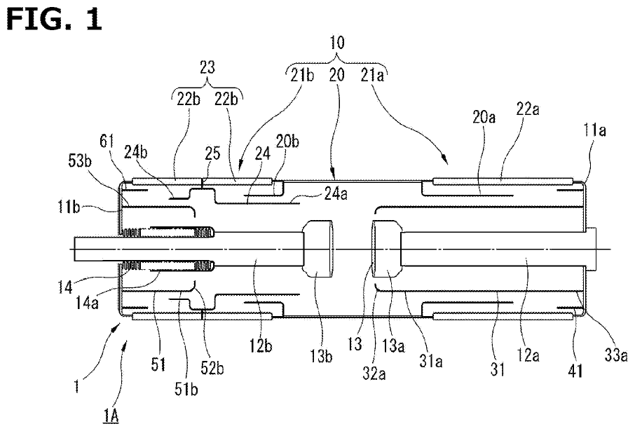

FIG. 1 is one for explaining a schematic configuration of a vacuum interrupter 1A according to the present embodiment. In the vacuum interrupter 1A, a vacuum vessel 1 is used in which the fixed side in the axial direction of an insulating cylindrical body 10 is sealed with a fixed-side flange 11a, and the movable side in the axial direction is sealed with a movable-side flange 11b. Although, in the fixed-side flange 11a and the movable-side flange 11b, various modes can be applied, the application of, for example, a metal flange can be cited.

In the vacuum vessel 1, a columnar fixed-side energizing shaft 12a is provided on the vacuum vessel 1 inner side of the fixed-side flange 11a so as to movably extend toward the movable side in the axial direction from the vacuum vessel 1 inner side. A fixed electrode 13a having, for example, a plate shape is supported on the end portion on the movable side in the axial direction (extending direction side) of the fixed-side energizing shaft 12a.

In the movable-side flange 11b, a columnar movable-side energizing shaft 12b is provided so as to extend in the axial direction while passing through the movable-side flange 11b in the axial direction. The movable-side energizing shaft 12b is supported on the vacuum vessel 1 inner side of the movable-side flange 11b via a cylindrical bellows 14 which is extensible in the axial direction and is arranged coaxially with the movable-side energizing shaft 12b. With this, the movable-side energizing shaft 12b can be moved in the axial direction.

In case of the movable-side energizing shaft 12b in FIG. 1, a cylindrical bellows shield 14a is provided so as to surround and cover the outer peripheral side of the bellows 14.

In addition, a movable electrode 13b having, for example, a plate shape is supported on the end portion on the vacuum vessel 1 inner side of the movable-side energizing shaft 12b, so as to come in contact with and separate from the fixed electrode 13a in accordance with the movement in the axial direction of the movable-side energizing shaft 12b.

The cylindrical body 10 is mainly provided with a cylindrical arc shield 20 surrounding the outer peripheral side of the fixed electrode 13a and the movable electrode 13b, a fixed-side insulating unit 21a provided so as to be connected to the fixed side in the axial direction of the arc shield 20, and movable-side insulators 22b provided so as to be connected to the movable side in the axial direction of the arc shield 20.

A fixed-side extending part 20a extending toward the fixed side in the axial direction along the inner peripheral side of the fixed-side insulating unit 21a is provided on the fixed side in the axial direction of the arc shield 20, and a movable-side extending part 20b extending toward the movable side in the axial direction along the inner peripheral side of the movable-side insulating unit 21b is provided on the movable side in the axial direction of the arc shield 20.

In case of the arc shield 20 in FIG. 1, the dimension in the axial direction of the fixed-side extending part 20a is longer than that in the axial direction of the movable-side extending part 20b. With this, the arc shield 20, as a whole, is configured so as to be biased toward the fixed side in the axial direction from contacts 13 of the fixed electrode 13a and the movable electrode 13b.

The fixed-side insulating unit 21a includes a cylindrical fixed-side insulator 22a, and the fixed-side insulator 22a is provided so as to be connected coaxially with the arc shield 20 on the fixed side in the axial direction of the arc shield 20.

The movable-side insulating unit 21b includes an insulator group 23 having a multistage insulating structure formed by a plurality of movable-side insulators 22b (two movable-side insulators 22b in FIG. 1), the number of which is larger than that of the fixed-side insulator 22a, and a cylindrical insulator-group-side sub shield 24 surrounding the outer peripheral side of the movable-side energizing shaft 12b.

The insulator group 23 is formed by arranging the movable-side insulators 22b so as to be aligned in the axial direction, and is provided so as to be connected coaxially with the art shield 20 on the movable side in the axial direction of the arc shield 20.

The insulator-group-side sub shield 24 is provided with an insulator-group-side sub shield support part 25 protruding from the outer peripheral surface of the insulator-group-side sub shield 24. The insulator-group-side sub shield support part 25 is supported by being interposed between two adjacent movable-side insulators 22b of the insulator group 23, and thereby the insulator-group-side sub shield 24 is supported by the insulator group 23.

In case of the insulator-group-side sub shield 24 in FIG. 1, the inner diameter of a one end portion 24a which is the fixed side in the axial direction of the insulator-group-side sub shield 24 is smaller than the inner diameter of an other end portion 24b which is the movable side in the axial direction of the insulator-group-side sub shield 24. In addition, the outer diameter of the one end portion 24a is smaller than the inner diameter of the movable-side extending part 20b. Moreover, the one end portion 24a is inserted into the inner peripheral side of the arc shield 20 (inner peripheral side of the movable-side extending part 20b) so as to be superimposed (overlap) with the arc shield 20 in the axial direction in a non-contact state with each other.

A cylindrical fixed-side sub shield 31 having a shape extending from the vacuum vessel 1 inner side toward the movable side in the axial direction is provided on the outer peripheral side of the fixed-side energizing shaft 12a on the fixed-side flange 11a side in the inside of the vacuum vessel 1, so as to surround the outer peripheral side of the fixed-side energizing shaft 12a.

In case of the fixed-side sub shield 31 in FIG. 1, the outer diameter of the fixed-side sub shield 31 is smaller than. the inner diameter of the fixed-side extending part 20a. In addition, a distal end portion 31a on the movable side in the axial direction (extending direction side) of the fixed-side sub shield 31. is inserted into the inner peripheral side of the arc shield 20 (inner peripheral side of the fixed-side extending part 20a), so as to be superimposed with the arc shield 20 in the axial direction in a non-contact state with each other. Moreover, the distal end portion 31a is formed with a reduced diameter portion 32a having a shape bent toward the axis side of the fixed-side sub shield 31, and is positioned more on the fixed side in the axial direction than the contacts 13 of the fixed electrode 13a and the movable electrode 13b.

In addition, a cylindrical fixed-side electric field relieving shield 41 having a shape extending from the vacuum vessel 1 inner side toward the movable side in the axial direction is provided on the outer peripheral edge side (outer peripheral side of the fixed-side sub shield 31) on the vacuum vessel 1 inner side of the fixed-side flange 11a, so as to surround the outer peripheral side of a root portion 33a of the fixed-side sub shield 31.

A cylindrical movable-side sub shield 51 having a shape extending from the vacuum vessel 1 inner side toward the fixed side in the axial direction is provided on the outer peripheral side of the movable-side energizing shaft 12b on the vacuum vessel 1 inner side of the movable-side flange 11b, so as to surround the outer peripheral side of the movable-side energizing shaft 12b.

In case of the movable-side sub shield 51 in. FIG. 1, the outer diameter of the movable-side sub shield 51 is smaller than the inner diameter of the other end portion 24b of the insulator-group-side sub shield 24. In addition, the inner diameter of the movable-side sub shield 51 is larger than the outer diameter of each of the movable-side energizing shaft 12b and the movable electrode 13b.

Moreover, a distal end portion 51b on the fixed side in the axial direction (extending direction side) of the movable-side sub shield 51 is inserted into the inner peripheral side of the insulator-group-side sub shield 24 (inner peripheral side of the other end portion 24b), so as to be superimposed with the insulator-group-side sub shield 24 in the axial direction in a non-contact state with each other. Furthermore, the distal end portion 51b is formed with a reduced diameter portion 52b having a shape bent toward the axis side of the movable-side sub shield 51.

In addition, a cylindrical movable-side electric field relieving shield 61 having a shape extending from the vacuum vessel 1 inner side toward the fixed side in the axial direction is provided on the outer peripheral edge side (outer peripheral side of the movable-side sub shield 51) on the vacuum vessel 1 inner side of the movable-side flange 11b, so as to surround the outer peripheral side of a root portion 53b of the movable-side sub shield 51.

According to the vacuum interrupter 1A shown in FIG. 1, on the fixed electrode 13a side of the vacuum interrupter 1A, as compared with the movable electrode 13b side, insulation distance can be secured easily, and creep discharge can be suppressed easily. On the other hand, on the movable electrode 13b side of the vacuum interrupter 1A, as compared with the fixed electrode 13a side, for example, the distance between adjacent electrodes according to each shield (for example, the distance between adjacent electrodes of the arch shield 20 and the insulator-group-side sub shield 24) is appropriately set, thereby easily adjusting electrostatic capacity.

<<Embodiment of Vacuum Breaker>>

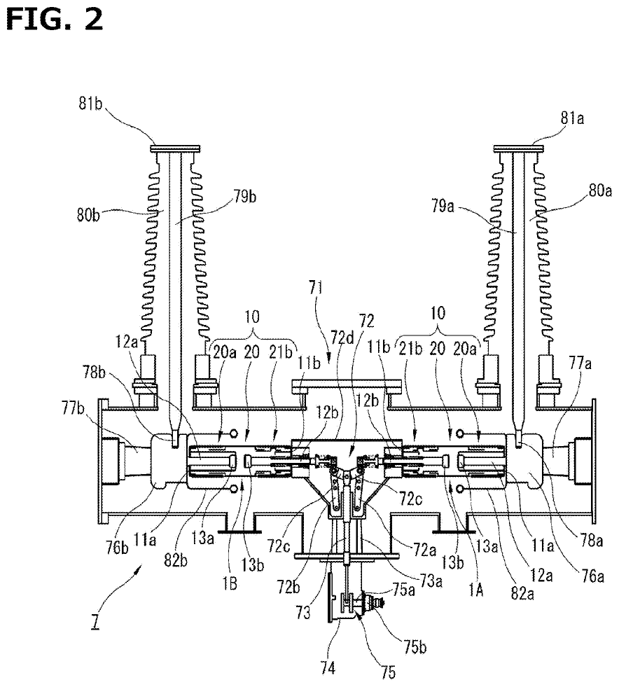

FIG. 2 is one for explaining a schematic configuration of a vacuum breaker 7 in the present embodiment. In addition, when a component of FIG. 2 is the same as that of FIG. 1, the same symbol is applied, and redundant explanation is omitted. For example, the configuration of the after-mentioned vacuum interrupter 1B is similar to that of the vacuum interrupter 1A, and its detailed explanation is appropriately omitted.

The vacuum breaker 7 includes a grounding tank 71, a pair of vacuum interrupters 1A, 1B accommodated in the grounding tank 71, and a link mechanism 72 interposed between the vacuum interrupters 1A, 1B so as to open and close the vacuum interrupters 1A, 1B.

The ground tank 71 is one formed by using, for example, a cylindrical metal vessel, and has a structure which is capable of accommodating the vacuum interrupters 1A, 1B so as to be arranged on the same line in a posture in which movable-side flanges 11b of the respective vacuum interrupters 1A, 1B face each other. The inside of the grounding tank 71 is filled with, for example, an insulating gas (for example, SF₆).

The link mechanism 72 includes a link 72a, a link 72b and a link 72c, and is accommodated in a link mechanism case 72d. One end portion of the link 72a is rotatably supported inside the link mechanism case 72d, and the other end portion of the link 72a is supported rotatably to a movable-side energizing shaft 12b of the vacuum interrupter 1A. In addition, one end portion of the link 72c is rotatably provided to the link 72a, and the other end portion of the link 72c is rotatably supported on one end portion of an insulation operation rod 73 provided for the opening and closing operation of the vacuum interrupter 1A.

Similarly, one end portion of the link 72b is rotatably supported inside the link mechanism case 72d, and the other end portion of the link 72b is supported rotatably to a movable-side energizing shaft 12b of the vacuum interrupter 1B. In addition, one end portion of a link 72c is rotatably supported on the link 72b, and an end portion of the link 72c is rotatably supported on one end portion of the insulation operation rod 73.

The link mechanism case 72d accommodates the link mechanism 72, and electrically connects the movable-side energizing shaft 12b of the vacuum interrupter 1A and the movable-side energizing shaft 12b of the vacuum interrupter 1B. In addition, the link mechanism case 72d is interposed between the movable-side flanges 11b of the respective vacuum interrupters 1A, 1B so as to be supported via a support insulating tube 73a provided on the inner peripheral surface of the grounding tank 71.

The insulation operation rod 73 is provided so as to be inserted through the side portions of the link mechanism case 72d, the support insulating tube 73a and the grounding tank 71. The insertion portion of the insulation operation rod 73 which is the outer peripheral side of the grounding tank 71 is provided with an operation part 74.

The operation part 74 accommodates a converting mechanism 75, and is configured so as to convert the rotation motion of a rotation shaft 75a into the liner motion of the insulation operation rod 73 via the converting mechanism 75. One end of the rotation shaft 75a is exposed from the outer peripheral side of the operation part 74 via a rotation seal part 75b. With this, in the outside of the operation part 74, an operation mechanism (not shown) for operating the insulation. operation rod 73 and an insulation operation rod (not shown) of another phrase can be driven interlocked with the rotation shaft 75a.

In the vacuum interrupter 1A, a conductor coupling part 76a electrically connected to the fixed-side energizing shaft 12a is provided on the outer side of the vacuum vessel 1 on the fixed-side flange 11a side, and is supported on the inner peripheral surface of the grounding tank 71 via a support insulator 77a. In addition, a conductor 79a is connected to the conductor coupling part 76a via a conductive metal fitting 78a.

Similar to the vacuum interrupter 1A, in the vacuum interrupter 1B, a conductor coupling part 76b electrically connected to the fixed-side energizing shaft 12a is provided on the outer side of the vacuum vessel 1 on the fixed-side flange 11a side, and is supported on the inner peripheral surface of the grounding tank 71 via a support insulator 77b. In addition, a conductor 79b is connected to the conductor coupling part 76b via a conductive metal fitting 78b.

The conductor 79a is provided in a state of protruding from the inside of the grounding tank 71 toward the outside of the grounding tank 71, and a bushing 80a is provided in the area surrounding the conductor 79a. The bushing 80a is supported on the grounding tank 71, and the distal end portion on the protruding direction side of the bushing 80a is provided with a bushing terminal 81a electrically connected to the conductor 79a.

Similar to the conductor 79a side, the conductor 79b is provided in a state of protruding from the inside of the grounding tank 71 toward the outside of the grounding tank 71, and a bushing 80b is provided in the area surrounding the conductor 79b. The bushing 80b is supported on the grounding tank 71, and the distal end portion on the protruding direction side of the bushing 80b is provided with a bushing terminal 81b electrically connected to the conductor 79b.

The outer peripheral side of the fixed-side insulating unit 21a of the vacuum interrupter 1A and the outer peripheral side of the fixed-side insulating unit 21a of the vacuum interrupter 1B are respectively provided with cylindrical outer-peripheral-side sub shields 82a, 82b surrounding the outer peripheral sides of the fixed-side insulating units 21a, and the outer-peripheral-side sub shield 82a is superimposed with the arc shield 20 of the vacuum interrupter 1A in the axial direction and the outer-peripheral-side sub shield 82b is superimposed with the arc shield 20 of the vacuum interrupter 1B in the axial direction.

In the input operation of the vacuum breaker 7 in FIG. 2, based on, for example, a desired input command, it is performed by the movement of the insulation operation rod 73 toward the inside direction (upper direction in FIG. 2) of the grounding tank 71 by a driving mechanism not shown (for example, a driving mechanism connected to the insulation operation rod 73). That is, the link 72c connected to the link 72a moves while tuning (in FIG. 2, rising while turning right) in accordance with the movement of the insulation operation rod 73. In accordance with this movement of the link 72c, the link 72a moves the movable-side energizing shaft 12b of the vacuum interrupter 1A toward the fixed electrode 13a side along the axial direction. Consequently, the fixed electrode 13a and the movable electrode 13b of the vacuum interrupter 1A are electrically connected to each other.

Similarly, the link 72c connected to the link 72b moves while tuning (in FIG. 2, rising while turning left) in accordance with the movement of the insulation operation rod 73. In accordance with this movement of the link 72c, the link 72b moves the movable-side energizing shaft 12b of the vacuum interrupter 1B toward the fixed electrode 13a side along the axial direction. Consequently, the fixed electrode 13a and the movable electrode 13b of the vacuum interrupter 1B are electrically connected to each other.

On the other hand, a cutoff operation is performed by the movement of the insulation operation rod 73 toward the outside direction (lower direction in FIG. 2) of the grounding tank 71. That is, by the operation reverse to the input operation, the movable-side energizing shaft 12b of the vacuum interrupter 1A moves in the direction separating from the vacuum interrupter 1A along the axial direction, and the movable electrode 13b separates from the fixed electrode 13a of the vacuum interrupter 1A.

Similarly, the movable-side energizing shaft 12b of the vacuum interrupter 1B moves in the direction separating from the vacuum interrupter 1B along the axial direction, and the movable electrode 13b separates from the fixed electrode 13a of the vacuum interrupter 1B.

In each of the vacuum interrupters 1A, 1B, in case of performing such an input operation and a cutoff operation mentioned above, even if the movable-side energizing shaft 12b moves, the vacuum state inside the vacuum vessel 1 is maintained by the extensible bellows 14. The bellows 14 of each of the vacuum interrupters 1A, 1B is one which is capable of withstanding the differential pressure between the vacuum on the outer peripheral side and an insulating gas (for example, SF₆) on the inner peripheral side to a certain extent.

<<Electrostatic Capacity Characteristic>>

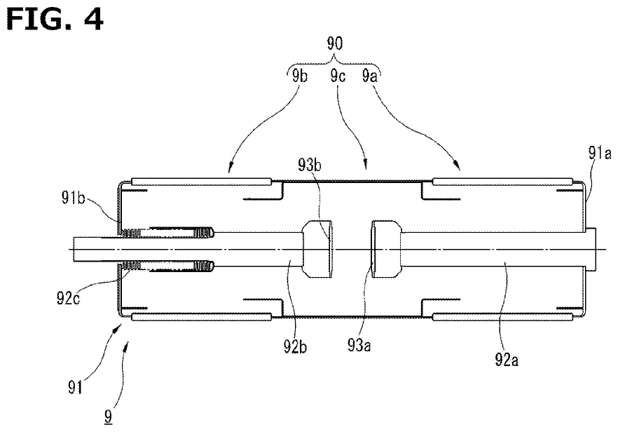

Next, electrostatic capacity characteristics of the vacuum breaker 7 shown in FIG. 2 will be explained while comparing with electrostatic capacity characteristics in case where the vacuum interrupter 9 shown in FIG. 4 is applied.

First, when focusing on the vacuum interrupter 9 shown in FIG. 4, since the configuration on the fixed side (fixed electrode 93 side) and the configuration on the movable side (movable electrode 93b side) in the axial direction of the vacuum interrupter 9 are symmetrical to each other, it can be understood that the electrostatic capacity between adjacent electrodes of the fixed-side energizing shaft 92a and the arc shield 9c is the same as that between adjacent electrodes of the movable-side energizing shaft 92b and the arc shield 9c. In addition, it can be considered that when an application voltage is set as 100%, the potential of the arc shield 9c is 50% (50% of the application voltage).

However, since the arc shield 9c acts as a floating electrode, in case where there is a grounding object such as a grounding tank around the arc shield 9c, the effect of an electrostatic capacity Cf between adjacent electrodes of the arc shield 9c and a grounding object can be considered. That is, the potential of the arc shield 9c is lowered, and the potential difference between a high voltage side and the arc shield 9c becomes large.

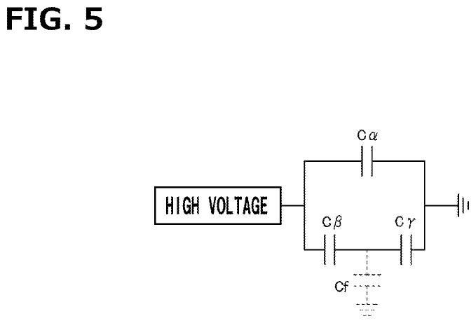

In case of accommodating such a vacuum interrupter 9 in a grounding tank of a vacuum breaker, its equivalent circuit is shown in FIG. 5. In addition, in FIG. 5, Cα indicates an electrostatic capacity between adjacent electrodes of the fixed electrode 93a and the movable electrode 93b, Cβ indicates an electrostatic capacity between adjacent electrodes of the movable-side energizing shaft 92b and the arc shield 9c, and Cγ indicates an electrostatic capacity between adjacent electrodes of the fixed-side energizing shaft 92a and the arc shield 9c.

In FIG. 5, it can be understood that, in order to suppress fluctuations in the potential of the arc shield 9c, the electrostatic capacities Cβ, Cγ need to be larger than the electrostatic capacity Cf.

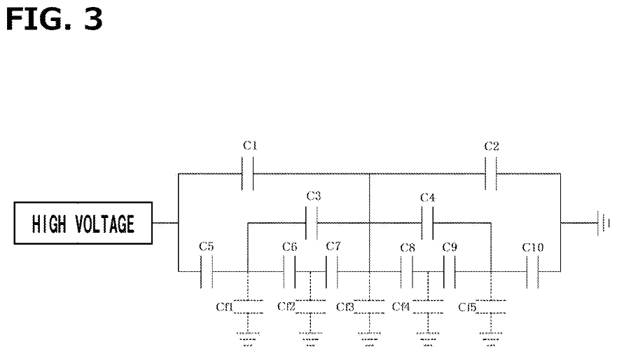

On the other hand, the equivalent circuit of the vacuum breaker 7 shown in FIG. 2 is as shown in FIG. 3. In addition, C1, C3, C5, C6, C7, Cf1 and Cf2 indicate electrostatic capacities according to the vacuum interrupter 1A, and C2, C4, C8, C9, C10, Cf4 and Cf5 indicate electrostatic capacities according to the vacuum interrupter 1B.

More specifically, C1 indicates an electrostatic capacity between adjacent electrodes of the fixed electrode 13a and the movable electrode 13b in the vacuum interrupter 1A, C2 indicates an electrostatic capacity between adjacent electrodes of the fixed electrode 13a and the movable electrode 13b in the vacuum interrupter 1B, C3 indicates an electrostatic capacity between adjacent electrodes of the arc shield 20 and the movable-side energizing shaft 12b in the vacuum interrupter 1A, C4 indicates an electrostatic capacity between adjacent electrodes of the arc shield 20 and the movable-side energizing shaft 12b in the vacuum interrupter 1B, C5 indicates an electrostatic capacity between adjacent electrodes of the arc shield 20 and the fixed-side energizing shaft 12a (or fixed-side sub shield 31) in the vacuum interrupter 1A, C10 indicates an electrostatic capacity between adjacent electrodes of the arc shield 20 and the fixed-side energizing shaft 12a (or fixed-side sub shield 31) in the vacuum interrupter 1B, C6 indicates an electrostatic capacity between adjacent electrodes of the arc shield 20 and the insulator-group-side sub shield 24 in the vacuum interrupter 1A, C9 indicates an electrostatic capacity between adjacent electrodes of the arc shield 20 and the insulator-group-side sub shield 24 in the vacuum interrupter 1B, C7 indicates an electrostatic capacity between adjacent electrodes of the movable-side energizing shaft 12b (or the movable-side sub shield 51) and the insulator-group-side sub shield 24 in the vacuum interrupter 1A, C8 indicates an electrostatic capacity between adjacent electrodes of the movable-side energizing shaft 12b (or the movable-side sub shield 51) and the insulator-group-side sub shield 24 in the vacuum interrupter 1B, Cf1 indicates an electrostatic capacity between adjacent electrodes of the arc shield 20 and the grounding tank 71 in the vacuum interrupter 1A, Cf5 indicates an electrostatic capacity between adjacent electrodes of the arc shield 20 and the grounding tank 71 in the vacuum interrupter 1B, Cf2 indicates an electrostatic capacity between adjacent electrodes of the insulator-group-side sub shield 24 and the grounding tank 71 in the vacuum interrupter 1A, Cf4 indicates an electrostatic capacity between adjacent electrodes of the insulator-group-side sub shield 24 and the grounding tank 71 in the vacuum interrupter 1B, and Cf3 indicates an electrostatic capacity between adjacent electrodes of the link mechanism 72 and the grounding tank 71.

In FIG. 2 and FIG. 3, it can be understood that a floating electrode in the vacuum breaker 7 mainly exists at five spots of the connection point (electrostatic capacity Cf3) in which the link mechanism 72 is accommodated, in addition to the arc shields 20 (electrostatic capacities CF1, Cf5), the insulator-group-side sub shields 24 (electrostatic capacities Cf2, Cf4) of the respective vacuum interrupters 1A, 1B.

In case of the vacuum breaker 7, in the vacuum interrupters 1A, 1B, the distance between contacts can be sufficiently separated at the time of contact opening, and it can be read that when the facing area of the arc shield 20 and the movable-side energizing shaft 12b is small, the values of the electrostatic capacities C1, C2, C3, C4 become small to a negligible extent, as compared with electrostatic capacities between adjacent electrodes of the others. That is, in order to equalize the potential sharing inside the vacuum breaker 7, it can be considered to increase the values of the electrostatic capacities C5-C10.

In general, in an electrostatic capacity C between adjacent electrodes of two cylindrical electrodes coaxially arranged like a vacuum interrupter, the relation shown in the following formula (1) is established.

In addition, in the following formula (1), “L” indicates the length in the axial direction of a cylindrical electrode, “a” indicates the radius of a cylindrical electrode on the inner side, “b” indicates the radius of a cylindrical electrode on the outer side, and “In” indicates a natural logarithm.

C=2πε74 L(ln(b/a)) (1)

In case of the vacuum breaker 7 shown in FIG. 2, as compared with the distance between adjacent electrodes of the arc shield 20 and the insulator-group-side sub shield 24 in each of the vacuum interrupters 1A, 1B (electrostatic capacities C6, C9) and the distance between adjacent electrodes of the insulator-group-side sub shield 24 and the movable-side sub shield 51 in each of the vacuum interrupters 1A, 1B (electrostatic capacities C7, C8), in the arc shield 20 and the fixed-side sub shield 31 in each of the vacuum interrupters 1A, 1B, the distance between adjacent electrodes (electrostatic capacities C5, C10) is large, and the superimposed distance is also large. Therefore, it can be understood that, each of the electrostatic capacities C5, C10 can be adjusted by mainly adjusting “L” in the formula (1).

In addition, since the outer-peripheral-side sub shields 82a, 82b are arranged so as to be superimposed with the respective arc shields 20, the electric field facing in the direction parallel to the creeping surface of each of the fixed-side insulating units 21 of the vacuum interrupters 1A, 1B can be bent in the vertical direction, and consequently, creeping discharge can be suppressed easier. Moreover, the potential distribution inside the vacuum breaker 7 can also be adjusted by shielding part of each of the electrostatic capacities Cf1, Cf5 generated between the arc shields 20 and the grounding tank 71.

Although the fixed-side sub shields 31 of the vacuum interrupters 1A, 1B are arranged in order to mainly adjust the electrostatic capacities between adjacent electrodes of the fixed-side sub shields 31 and the arch shields 20, by adjusting each of the distal end portions 31a of the fixed-side sub shields 31 so as to extend to a position near corresponding one of the contacts 13, the electric fields of the contacts 13 can also be relaxed.

However, if the fixed-side sub shields 31 are adjusted such that the distal end portions 31a extend to positions more on the movable side in the axial direction than the contacts 13, there is a possibility that the arc generated when electric current is cut off is ignited to the fixed-side sub shields 31, and breaking performance deteriorates. Therefore, it is preferable to adjust and extend the fixed-side sub shields 31 such that the distal end portions 31a are positioned more on the fixed side in the axial direction than the contacts 13 as shown in FIG. 1 and FIG. 2.

In addition, in case where the fixed-side sub shields 31 are arranged in order to only adjust electrostatic capacity as mentioned above, it can be substituted by increasing the size of the fixed-side energizing shafts 12a.

In the electrostatic capacities C6-C9, by decreasing the distance between adjacent electrodes in each of them, the denominator in the formula (1) is made small, and the electrostatic capacities can be increased. In general, it is known that the dielectric breakdown voltage in vacuum is proportional to the approximately 0.5 power of the distance. That is, in case where, in each of the electrostatic capacities, an insulation distance D is the same, as compered with case where insulation is secured at one spot, in the configuration in which electrodes having a half distance d/2 therebetween are provided at two spots, a compact design can be realized.

In case of the vacuum breaker 7 in FIG. 3, four electrodes (C6-C9) exist between arc shields of the respective vacuum interrupters 1A, 1B. That is, even if the distance between electrodes is reduced in order to form a high electrostatic capacity, it is possible to design the vacuum breaker 7 in order to sufficiently maintain a desired dielectric breakdown characteristic in the vacuum interrupters 1A, 1B.

The vacuum breaker 7 mentioned above can also be considered which have a configuration in which characteristics of a so-called double-break vacuum breaker are combined with the dielectric breakdown phenomenon in vacuum. In addition, even if a voltage sharing capacitor as shown in the patent document 3 is not used, the potential distribution inside the vacuum breaker 7 can be appropriately adjusted, and an increase in voltage and a decrease in size of the vacuum breaker 7 become possible.

As the above, although one embodiment of the present invention has been explained in detail, it is obvious to a person skilled in the art that the present invention is not limited to the above embodiment, and various changes can be carried out within the technical scope of the present invention, and it is obvious that such a change belongs to the scope of the claims.

1. A vacuum interrupter comprising:
a vacuum vessel including an insulating cylindrical body, and having a fixed side which is one end side in an axial direction of the cylindrical body and is sealed with a fixed-side flange and a movable side which is an other end side in the axial direction and is sealed with a movable-side flange;
a fixed-side energizing shaft extending from a vacuum vessel inner side of the fixed-side flange in the axial direction;
a fixed electrode supported on an end portion on an extending direction side of the fixed-side energizing shaft;
a movable-side energizing shaft which extends in the axial direction while passing through the movable-side flange in the axial direction, and is supported on the vacuum vessel inner side of the movable-side flange via a bellows which is extensible in the axial direction, so as to be movable in the axial direction; and
a movable electrode which is supported on an end portion on the vacuum vessel inner side of the movable-side energizing shaft so as to face the fixed electrode, and comes in contact with and separates from the fixed electrode in accordance with a movement of the movable-side energizing shaft,
wherein the cylindrical body includes:
a cylindrical arc shield which surrounds an outer peripheral side of the fixed electrode and the movable electrode;
a fixed side insulating unit in which a cylindrical fixed-side insulator is provided so as to be connected coaxially with the arc shield on the fixed side in the axial direction of the arc shield; and
a movable-side insulating unit in which cylindrical movable-side insulators are provided so as to be connected coaxially with the arc shield on the movable side in the axial direction of the arc shield, and
wherein the movable-side insulating unit includes:
an insulator group in which a plurality of the movable-side insulators, a number of which is larger than that of the fixed-side insulator, are provided so as to be connected in the axial direction;
a cylindrical insulator-group-side sub shield surrounding an outer peripheral side of the movable-side energizing shaft; and
an insulator-group-side sub shield support part which is provided on an outer peripheral surface of the insulator-group-side sub shield, and is supported by being interposed between two adjacent movable-side insulators of the insulator group.

2. The vacuum interrupter according to claim 1, wherein an inner diameter on the fixed side in the axial direction of the insulator-group-side sub shield is smaller than that on the movable side in the axial direction of the insulator-group-side sub shield.

3. The vacuum interrupter according to claim 1, further comprising a cylindrical movable-side sub shield which extends from the vacuum vessel inner side of the movable-side flange in the axial direction and surrounds an outer peripheral side of the movable-side energizing shaft, on an inner peripheral side of the insulator-group-side sub shield,
wherein an outer diameter of the movable-side sub shield is smaller than an inner dimeter of the insulator-group-side sub shield, and
wherein an inner diameter of the movable-side sub shield is larger than an outer diameter of the movable-side energizing shaft and an outer diameter of the movable electrode.

4. The vacuum interrupter according to claim 3, wherein an distal end portion on an extending direction side of the movable-side sub shield is formed with a movable-side reduced diameter portion having a shape bent toward an axis side of the movable-side sub shield.

5. The vacuum interrupter according to claim 1, further comprising a cylindrical fixed-side sub shield which extends from the vacuum vessel inner side of the fixed-side flange in the axial direction and surrounds an outer peripheral side of the fixed-side energizing shaft, on an inner peripheral side of the arc shield,
wherein an outer diameter of the fixed-side sub shield is smaller than an inner dimeter of the arc shield, and a distal end portion on an extending direction side of the fixed-side sub shield is positioned more on the fixed side in the axial direction than contacts of the fixed electrode and the movable electrode.

6. The vacuum interrupter according to claim 5, wherein the distal end portion on the extending direction side of the fixed-side sub shield is formed with a fixed-side reduced diameter portion having a shape bent toward an axis side of the fixed-side sub shield.

7. The vacuum interrupter according to claim 1, wherein a center position in the axial direction of the arc shield is biased toward the fixed side in the axial direction from contacts of the fixed electrode and the movable electrode.

8. The vacuum interrupter according to claim 1, wherein an outer diameter on the fixed side in the axial direction of the insulator-group-side sub shield is smaller than an inner diameter on the movable side in the axial direction of the arc shield, and
wherein the fixed side in the axial direction of the insulator-group-side sub shield is inserted into an inner peripheral side of the arc shield so as to be superimposed with the arc shield in the axial direction in a non-contact state with each other.

9. A vacuum breaker provided with a pair of the vacuum interrupters according to claim 1, comprising:
a grounding tank which accommodates the pair of the vacuum interrupters arranged on a same line in a posture in which the movable-side flanges of the pair of the respective vacuum interrupters face each other;
a link mechanism which is provided inside the grounding tank and electrically connects the movable-side energizing shafts of the pair of the respective vacuum interrupters so as to be freely movable in the axial direction; and
an operation part which is provided on an outer peripheral side of the grounding tank and operates the link mechanism via an insulation operation rod connected to the link mechanism.

10. The vacuum breaker according to claim 9, wherein cylindrical outer-peripheral-side sub shields surrounding respective outer peripheral sides of the fixed-side insulating units of the pair of the vacuum interrupters are provided on the respective outer peripheral sides of the fixed-side insulating units, and
wherein each of the outer-peripheral-side sub shields is superimposed with corresponding one of the arc shields of the vacuum interrupters in the axial direction.
